(19) United States
(12) Patent Application Publication
(10) Pub. No.: US 2019/0376589 A1
(43) Pub. Date: Dec. 12, 2019

(54) Parallel Strong Hybrid Electric Vehicle (Hev) Powertrain Assembly With Torque Converter

(71) Applicant: GM Global Technology Operations LLC, Detroit, MI (US)

(72) Inventors: Farzad Samie, Franklin, MI (US); Derek F. Lahr, Howell, MI (US); Dongxu Li, Troy, MI (US); Chunhao J. Lee, Troy, MI (US); Norman K. Bucknor, Troy, MI (US)

(21) Appl. No.: 16/002,735

(22) Filed: Jun. 7, 2018

(51) Int. Cl. F16H 41/24; B60K 6/48; B60K 6/40; F16H 41/04; H02K 7/00; H02K 9/19

(52) U.S. Cl. CPC F16H 41/24; B60K 6/48; B60K 6/40; F16H 41/04; B60Y 2306/03; H02K 9/19; B60Y 2200/92; B60Y 2400/426; Y10S 903/951; H02K 7/006

(57) ABSTRACT

A parallel (P2) hybrid electric vehicle (HEV) powertrain assembly includes a torque converter and a motor-generator unit (MGU). The parallel hybrid electric vehicle (HEV) powertrain assembly can be equipped in a front wheel drive (FWD) powertrain architecture. The torque converter has an impeller cover. The motor-generator unit has a rotor and a stator. The rotor extends from the impeller cover, and the stator is mounted to a transmission bell housing.

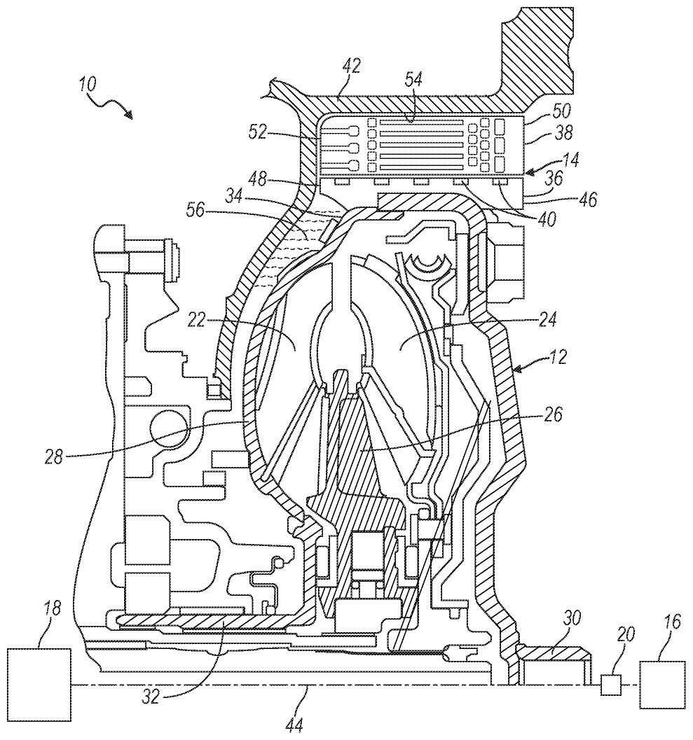

### INTRODUCTION

The present disclosure relates to hybrid electric vehicle (HEV) powertrain architectures, and more particularly relates to parallel (P2) hybrid electric vehicle powertrain architectures.

A hybrid electric vehicle powertrain architecture is commonly equipped with a motor-generator unit (MGU) that can serve as both a generator and a motor, and an internal combustion engine that can provide power to drive wheels of the larger vehicle. Further, automatic transmissions are often equipped with a torque converter that utilizes fluid to transfer torque from the internal combustion engine to a downstream transmission. Packaging in a hybrid electric vehicle powertrain architecture can be demanding and, in some cases, even inflexible, and hence can dictate the selected components and their arrangement within the powertrain architecture.

### SUMMARY

In an embodiment, a parallel hybrid electric vehicle (HEV) powertrain assembly may include a torque converter and a motor-generator unit (MGU). The torque converter has an impeller cover. The motor-generator unit has a rotor and a stator. The rotor extends from the impeller cover at an outboard side of the impeller cover. The rotor co-rotates with the impeller cover during use of the parallel hybrid electric vehicle powertrain assembly. The stator is mounted to a powertrain housing at an inboard side of the powertrain housing. The stator's mounting is near the rotor.

In an embodiment, the rotor of the motor-generator unit carries one or more permanent magnets.

In an embodiment, the rotor of the motor-generator unit extends directly from an exterior surface of the impeller cover.

In an embodiment, the stator of the motor-generator unit is mounted directly to an interior surface of the powertrain housing

In an embodiment, the rotor of the motor-generator unit extends from the impeller cover at a location that is radially outboard of an impeller of the torque converter. The location is also radially outboard of a turbine of the torque converter.

In an embodiment, a first axial extent of the motor-generator unit generally overlaps with a second axial extent of an impeller of the torque converter, of a turbine of the torque converter, or of both the impeller of the torque converter and the turbine of the torque converter.

In an embodiment, the torque converter augments rotational torque transfer of the motor-generator unit amid use of the parallel hybrid electric vehicle powertrain assembly.

In an embodiment, the torque converter includes an impeller, a turbine, and a stator. The impeller cover partly or more houses the impeller, the turbine, the stator, or a combination of these components.

In an embodiment, lubricant is contained within the powertrain housing. The motor-generator unit has exposure to the lubricant amid use of the parallel hybrid electric vehicle powertrain assembly.

In an embodiment, the parallel hybrid electric vehicle powertrain assembly is a front wheel drive (FWD) parallel hybrid electric vehicle powertrain assembly.

In an embodiment, a parallel hybrid electric vehicle (HEV) powertrain assembly may include a torque converter and a motor-generator unit (MGU). The torque converter has an impeller cover. The motor-generator unit has a rotor and a stator. The rotor carries one or more permanent magnets. The rotor extends from an exterior surface of the impeller cover. The rotor co-rotates with the impeller cover amid use of the parallel hybrid electric vehicle powertrain assembly. The stator is mounted to an interior surface of a transmission bell housing.

In an embodiment, the rotor of the motor-generator unit extends from the impeller cover at a location that is radially outboard of an impeller of the torque converter. The location is also radially outboard of a turbine of the torque converter.

In an embodiment, a first axial extent of the motor-generator unit generally exhibits an overlapping arrangement with a second axial extent of an impeller of the torque converter, of a turbine of the torque converter, or of both the impeller of the torque converter and the turbine of the torque converter.

In an embodiment, the torque converter augments rotational torque transfer of the motor-generator unit amid use of the parallel hybrid electric vehicle powertrain assembly.

In an embodiment, the torque converter includes an impeller, a turbine, and a stator. The impeller cover partly or more houses the impeller, the turbine, the stator, or a combination of these components.

In an embodiment, lubricant is contained within the transmission bell housing. The motor-generator unit has exposure to the lubricant amid use of the parallel hybrid electric vehicle powertrain assembly.

In an embodiment, the parallel hybrid electric vehicle powertrain assembly is a front wheel drive (FWD) parallel hybrid electric vehicle powertrain assembly.

In an embodiment, a front wheel drive (FWD) parallel hybrid electric vehicle (HEV) powertrain assembly may include a torque converter and a motor-generator unit (MGU). The torque converter includes an impeller, a turbine, and a stator. The stator is situated between the impeller and the turbine. The torque converter further includes an impeller cover. The motor-generator unit has a rotor and a stator. The rotor carries one or more permanent magnets. The rotor extends from an exterior surface of the impeller cover. The stator is mounted to an interior surface of a transmission bell housing. The rotor of the motor-generator unit extends from the impeller cover at a location that is radially outboard of the impeller of the torque converter. The location is also radially outboard of the turbine of the torque converter. The torque converter augments rotational torque transfer of the motor-generator unit amid use of the front wheel drive parallel hybrid electric vehicle powertrain assembly.

In an embodiment, the rotor co-rotates with the impeller cover amid use of the front wheel drive parallel hybrid electric vehicle powertrain assembly by virtue of its extension therefrom.

In an embodiment, a first axial extent of the motor-generator unit generally overlaps with a second axial extent of the impeller of the torque converter, of the turbine of the torque converter, or of both the impeller of the torque converter and the turbine of the torque converter.

### BRIEF DESCRIPTION OF THE DRAWING

One or more aspects of the disclosure will hereinafter be described in conjunction with the appended drawing, wherein like designations denote like elements, and wherein:

The FIGURE presents a schematic depiction of an embodiment of a parallel strong hybrid electric vehicle powertrain assembly.

### DETAILED DESCRIPTION

Referring to the drawing, a parallel strong (P2) hybrid electric vehicle (HEV) powertrain architecture and assembly 10 (hereafter, HEV powertrain assembly) is designed and constructed to satisfy the packaging demands that arise when equipping the HEV powertrain assembly 10 with a torque converter 12 and a motor-generator unit (MGU) 14. Such packaging demands can be particularly challenging when the HEV powertrain assembly 10 is furnished for a front wheel drive (FWD) vehicle, which the HEV powertrain assembly 10 is indeed further designed and constructed to satisfy. As described below, the motor-generator unit 14 is packaged to have a construction that is partly integrated with the torque converter 12—in this way, a higher voltage motor-generator unit 14 can be employed in the HEV powertrain assembly 10, a reduced-sized torque converter 12 can be employed, or both a higher voltage motor-generator unit 14 and reduced-sized torque converter 12 can be employed, among other possible advances. Moreover, the motor-generator unit 14, in combination with the torque converter 12, can aid in effecting launch of the larger vehicle. The vehicle can ultimately exhibit improved drivability. The HEV powertrain assembly 10 is described below in the context of an automotive application, yet could be equipped in non-automotive applications as well.

The HEV powertrain assembly 10 can have different designs, constructions, and components in different embodiments depending upon—among other possible factors—the designs and constructions and components of upstream and downstream portions of the associated powertrain in which the HEV powertrain assembly 10 is equipped. In the embodiment of the FIGURE, the HEV powertrain assembly 10 includes the torque converter 12 and the motor-generator unit 14.

The torque converter 12 transfers torque from a vehicle internal combustion engine 16 and to a vehicle transmission 18. The FIGURE further depicts a disconnect mechanism 20, such as a clutch, that could be installed between the vehicle engine 16 and the torque converter 12. One or more of these components—vehicle engine 16, vehicle transmission 18, and disconnect mechanism 20—can constitute additional components of the HEV powertrain assembly 10 in various embodiments. The torque converter 12 receives rotational drive input from the vehicle engine 16 and transmits rotational drive output downstream to the vehicle transmission 18. The torque converter 12 can take different forms in different embodiments. In the embodiment presented by the FIGURE, the torque converter 12 primarily includes a pump or impeller 22, a turbine 24, a stator 26, and an impeller shell or cover 28. Other components of the torque converter 12 include an input shaft 30 and an output hub 32. In general, skilled artisans will appreciate how the torque converter 12 operates and how its components work together to carry out its torque-transferring functionality, and therefore a detailed description of such is not presented here. The impeller cover 28, in this embodiment, houses and provides at least partial support for the impeller 22, turbine 24, and/or stator 26. The impeller cover 28 revolves with the impeller 22 during use of the torque converter 12, and has an exterior surface 34.

The motor-generator unit 14 serves as both a generator and a motor amid use of the HEV powertrain assembly 10. The motor-generator unit 14 can take different forms in different embodiments. In the embodiment of the FIGURE, the motor-generator unit 14 includes a rotor 36 and a stator 38. The rotor 36 constitutes the rotating member of the motor-generator unit 14. The rotor 36 carries one or more permanent magnets 4 in its body. In assembly and installation, and with relation to the torque converter 12, the rotor 36 is located at an outboard side of the impeller cover 28. Here, the rotor 36 is positioned at an exterior of the torque converter 12 and at an exterior of the impeller cover 28, and is positioned at an interior of a transmission bell housing 42. The location of the rotor 36 is radially outboard of the impeller 22, radially outboard of the turbine 24, radially outboard of the stator 26, and radially outboard of the impeller cover 28 (the term “radially” is used here with respect to a generally circular shape of the torque converter 12 and relative to an axis 44). Moreover, and with further relation to the torque converter 12, a first axial extent of the rotor 36 taken between a first side 46 and a second side 48 exhibits an overlapping arrangement and relationship with a second axial extent of one or more components of the torque converter 12 including the impeller 22 and/or the turbine 24. The overlapping arrangement is constituted by a common axial extent between the first and second axial extents. The second axial extent is defined similarly as the first axial extent—that is, an axial side-to-side length of the impeller 22 and/or an axial side-to-side length of the turbine 24.

As illustrated in the FIGURE, the rotor 36 extends from the impeller cover 28 at a topside thereof. Its extension can be effected in various ways. In one embodiment, the rotor 36 is initially a separate and distinct component that is subsequently attached directly to the exterior surface 34 of the impeller cover 28 (the term “directly” as used here is intended to mean without any substantial intervening components and/or structures). The attachment could be carried out in different manners, including via welding, bolting, or other techniques. In another embodiment, the rotor 36 is attached to the exterior surface 34 of the impeller cover 28 via an intermediate component and/or structure. Still, the attachment between the rotor 36 and impeller cover 28 could occur in other ways. In yet an additional embodiment, the rotor 36 is a unitary extension of the impeller cover 28—here, the permanent magnet(s) 40 are, in a sense, integrated into the construction of the impeller cover 28. By virtue of its extension, the rotor 36 co-rotates and revolves concurrently with the impeller cover 28 amid use of the HEV powertrain assembly 10.

The stator 38 constitutes the non-rotating member of the motor-generator unit 14. In assembly and installation, and with relation to the torque converter 12, the stator 38 is located at an outboard side of the impeller cover 28. With relation to the transmission bell housing 42, the stator 38 is located at an inboard side thereof. Here, the stator 38 is positioned at the exterior of the torque converter 12 and at the exterior of the impeller cover 28, and is positioned at the interior of the transmission bell housing 42. The stator 38 and rotor 36 confront and oppose each other across a gap therebetween, as depicted in the FIGURE. The location of the stator 38 is radially outboard of the impeller 22, radially outboard of the turbine 24, radially outboard of the stator 26, and radially outboard of the impeller cover 28 (the term “radially” is used here with respect to the generally circular shape of the torque converter 12 and relative to the axis 44). Moreover, and with further relation to the torque converter 12, a third axial extent of the stator 38 taken between a first side 50 and a second side 52 exhibits an overlapping arrangement and relationship with the second axial extent of one or more components of the torque converter 12 including the impeller 22 and/or the turbine 24. The overlapping arrangement is constituted by a common axial extent between the third and second axial extents. In this embodiment, the third axial extent is substantially equivalent to the first axial extent.

As illustrated in the FIGURE, the stator 38 is mounted to the transmission bell housing 42 at a underside thereof Its mounting can be effected in various ways. In one embodiment, the stator 38 is mounted directly to an interior surface 54 of the transmission bell housing 42 (as before, the term “directly” as used here is intended to mean without any substantial intervening components and/or structures). The mounting can involve welding, bolting, or other techniques. In another embodiment, the stator 38 is mounted to the interior surface 54 via an intermediate component and/or structure. Still, the mounting between the stator 38 and the transmission bell housing 42 could occur in other ways.

Furthermore, with the motor-generator unit 14 located as set forth above, lubricant 56 can be contained within the interior of the transmission bell housing 42 in order to provide cooling to the rotor 36 and to the stator 38 amid operation of the motor-generator unit 14. In this regard, the transmission bell housing 42 would be termed a wet transmission bell housing. When present, the motor-generator unit 14 is partly or more exposed to the lubricant 56, as schematically represented in the FIGURE.

As described, the HEV powertrain assembly 10 satisfies the packaging demands that arise when equipping the HEV powertrain assembly 10 with the torque converter 12 and the motor-generator unit 14. Placement and installation of the rotor 36 and stator 38, as set forth above, obviates the need to add to the overall axial length of the HEV powertrain assembly 10 and vehicle transmission 18, as is often otherwise called for and can present certain challenges. Additions to the overall axial length can be particularly challenging for front wheel drive HEV powertrain assemblies. Rather, the HEV powertrain assembly 10 has the motor-generator unit 14 placed and installed radially relative to the torque converter 12 and, as a result, the HEV powertrain assembly 10 is suitable for a front wheel drive hybrid electric vehicle powertrain assembly, and is particularly suitable for a parallel strong front wheel drive hybrid electric vehicle powertrain. In the embodiments described, the torque converter 12 augments rotational torque transfer of the motor-generator unit 14 and aids the motor-generator unit 14 in carrying out launch operations of the larger vehicle. In this regard, the torque converter 12 can have a reduced size compared to its size if it lacked the motor-generator unit 14, and the motor-generator unit 14 can possess a higher voltage compared to its voltage if it were installed elsewhere.

In other embodiments, the torque converter 12 and the motor-generator unit 14 could be placed at other locations within a powertrain assembly apart from the vehicle transmission 18, and hence could be positioned within a powertrain housing other than the transmission bell housing 42.

It is to be understood that the foregoing is a description of one or more aspects of the disclosure. The disclosure is not limited to the particular embodiment(s) disclosed herein, but rather is defined solely by the claims below. Furthermore, the statements contained in the foregoing description relate to particular embodiments and are not to be construed as limitations on the scope of the disclosure or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A parallel hybrid electric vehicle (HEV) powertrain assembly, comprising:
a torque converter having an impeller cover; and
a motor-generator unit (MGU) having a rotor and a stator, the rotor extending from the impeller cover at an outboard side of the impeller cover and co-rotating with the impeller cover during use of the parallel hybrid electric vehicle powertrain assembly, and the stator being mounted to a powertrain housing at an inboard side of the powertrain housing and adjacent the rotor.

2. The parallel hybrid electric vehicle (HEV) powertrain assembly of claim 1, wherein the rotor of the motor-generator unit carries at least one permanent magnet.

3. The parallel hybrid electric vehicle (HEV) powertrain assembly of claim 1, wherein the rotor of the motor-generator unit extends directly from an exterior surface of the impeller cover.

4. The parallel hybrid electric vehicle (HEV) powertrain assembly of claim 1, wherein the stator of the motor-generator unit is mounted directly to an interior surface of the powertrain housing.

5. The parallel hybrid electric vehicle (HEV) powertrain assembly of claim 1, wherein the rotor of the motor-generator unit extends from the impeller cover at a location that is radially outboard of an impeller of the torque converter and that is radially outboard of a turbine of the torque converter.

6. The parallel hybrid electric vehicle (HEV) powertrain assembly of claim 1, wherein a first axial extent of the motor-generator unit generally overlaps with a second axial extent of at least one of an impeller of the torque converter or of a turbine of the torque converter.

7. The parallel hybrid electric vehicle (HEV) powertrain assembly of claim 1, wherein the torque converter augments rotational torque transfer of the motor-generator unit during use of the parallel hybrid electric vehicle powertrain assembly.

8. The parallel hybrid electric vehicle (HEV) powertrain assembly of claim 1, wherein the torque converter further includes an impeller, a turbine, and a stator, and wherein the impeller cover at least partly houses the impeller, turbine, stator of the torque converter, or a combination of these components.

9. The parallel hybrid electric vehicle (HEV) powertrain assembly of claim 1, wherein lubricant is contained within the powertrain housing, the motor-generator unit being at least partly exposed to the contained lubricant during use of the parallel hybrid electric vehicle powertrain assembly.

10. The parallel hybrid electric vehicle (HEV) powertrain assembly of claim 1, wherein the parallel hybrid electric vehicle powertrain assembly is a front wheel drive (FWD) parallel hybrid electric vehicle powertrain assembly.

11. A parallel hybrid electric vehicle (HEV) powertrain assembly, comprising:
a torque converter having an impeller cover; and
a motor-generator unit (MGU) having a rotor and a stator, the rotor carrying at least one permanent magnet, the rotor extending from an exterior surface of the impeller cover and co-rotating with the impeller cover during use of the parallel hybrid electric vehicle powertrain assembly, and the stator being mounted to an interior surface of a transmission bell housing.

12. The parallel hybrid electric vehicle (HEV) powertrain assembly of claim 11, wherein the rotor of the motor-generator unit extends from the impeller cover at a location that is radially outboard of an impeller of the torque converter and that is radially outboard of a turbine of the torque converter.

13. The parallel hybrid electric vehicle (HEV) powertrain assembly of claim 11, wherein a first axial extent of the motor-generator unit exhibits an overlapping arrangement with a second axial extent of at least one of an impeller of the torque converter or of a turbine of the torque converter.

14. The parallel hybrid electric vehicle (HEV) powertrain assembly of claim 11, wherein the torque converter augments rotational torque transfer of the motor-generator unit during use of the parallel hybrid electric vehicle powertrain assembly.

15. The parallel hybrid electric vehicle (HEV) powertrain assembly of claim 1, wherein the torque converter further includes an impeller, a turbine, and a stator, and wherein the impeller cover at least partly houses the impeller, turbine, stator of the torque converter, or a combination of these components.

16. The parallel hybrid electric vehicle (HEV) powertrain assembly of claim 1, wherein lubricant is contained within the transmission bell housing, the motor-generator unit being at least partly exposed to the contained lubricant during use of the parallel hybrid electric vehicle powertrain assembly.

17. The parallel hybrid electric vehicle (HEV) powertrain assembly of claim 1, wherein the parallel hybrid electric vehicle powertrain assembly is a front wheel drive (FWD) parallel hybrid electric vehicle powertrain assembly.

18. A front wheel drive (FWD) parallel hybrid electric vehicle (HEV) powertrain assembly, comprising:
a torque converter including an impeller, a turbine, and a stator situated between the impeller and turbine, the torque converter further including an impeller cover; and
a motor-generator unit (MGU) having a rotor and a stator, the rotor carrying at least one permanent magnet, the rotor extending from an exterior surface of the impeller cover, and the stator being mounted to an interior surface of a transmission bell housing;
wherein the rotor of the motor-generator unit extends from the impeller cover at a location that is radially outboard of the impeller of the torque converter and that is radially outboard of the turbine of the torque converter; and
wherein the torque converter augments rotational torque transfer of the motor-generator unit during use of the front wheel drive parallel hybrid electric vehicle powertrain assembly.

19. The front wheel drive (FWD) parallel hybrid electric vehicle (HEV) powertrain assembly of claim 18, wherein the rotor co-rotates with the impeller cover during use of the front wheel drive parallel strong hybrid electric vehicle powertrain assembly.

20. The front wheel drive (FWD) parallel hybrid electric vehicle (HEV) powertrain assembly of claim 19, wherein a first axial extent of the motor-generator unit generally overlaps with a second axial extent of at least one of the impeller of the torque converter or of the turbine of the torque converter.
